(19) United States
(12) Patent Application Publication
(10) Pub. No.: US 2012/0155110 A1
(43) Pub. Date: Jun. 21, 2012

(54) LIGHT GUIDE, ILLUMINATION SYSTEM, BACKLIGHTING SYSTEM AND DISPLAY DEVICE

(75) Inventors: Fetze Pijlman, Eindhoven (NL); Maarten Marinus Johannes Wilhelm Van Herpen, Eindhoven (NL); Menno Van Baardwijk, Eindhoven (NL)

(73) Assignee: KONINKLIJKE PHILIPS ELECTRONICS N.V., EINDHOVEN (NL)

(21) Appl. No.: 13/392,889

(22) PCT Filed: Sep. 9, 2010
(86) PCT No.: PCT/IB10/54073

§ 371 Date: Feb. 28, 2012

(30) Foreign Application Priority Data
Sep. 23, 2009 (EP) 09171052.5

(51) Int. Cl. G09F 13/04; F21V 7/00; F21V 8/00

(52) U.S. Cl. 362/602; 362/616; 362/609

(57) ABSTRACT

The invention relates to a light guide (10) for illuminating a light output window (120) of an illumination system (100), the illumination system, a backlighting system (100) and a display device (200). The light guide comprises a first light guide part (10A) comprising a first light guide extension (70A) extending from a first edge wall (40A) of the first light guide part (10A), and comprises a second light guide part (10B) comprising a second light guide extension (70B) extending from a second edge wall (40B) of the second light guide part (10B), the first light guide extension (70A) being configured for positioning a first light input window (80A) at a side of the second light guide part (10β) facing a rear wall (30B) of the second light guide part (10B), the second light guide extension (70B) being configured for positioning a second light input window (80B) at a side of the first light guide part (10A) facing the rear wall (30A) of the first light guide part. An effect of the light guide according to the invention is that due to the configuration of the first light guide extension and the second light guide extension, the first light input window of the first light guide part is arranged behind the second light guide part, and the second light input window of the second light guide part is arranged behind the first light guide part.

### FIELD OF THE INVENTION

The invention relates to a light guide for illuminating a light output window of an illumination system.

The invention also relates to an illumination system, a backlighting system and a display device.

### BACKGROUND OF THE INVENTION

Light guides for illuminating a light output window of the illumination system are known per se. They are used, inter alia, in general illumination systems and in backlighting systems for (picture) display devices, for example, for TV sets and monitors. Such light guides are particularly suitable for use as backlighting systems for non-emissive display devices such as liquid crystal display devices, also denoted as LCD panels, which are used in, for example, (portable) computers or, for example, (portable) telephones.

Said non-emissive display devices usually comprise a substrate provided with a regular pattern of pixels which are each controlled by at least one electrode. The display device utilizes a control circuit for achieving a picture or a data graphical display in a relevant field of a (picture) screen of the (picture) display device. The light originating from the illumination system in an LCD device is modulated by means of a switch or modulator in which, for example, various types of liquid crystal effects may be used. In addition, the display may be based on electrophoretic or electromechanical effects.

Currently, there are two commonly used configurations for illumination system for non-emissive display devices, the direct-lit configuration and the edge-lit configuration. In the direct-lit configuration, the light sources are arranged in an array substantially parallel to the light output window of the illumination system and are arranged to substantially directly illuminate the whole output window of the illumination system. In the edge-lit configuration, the illumination system generally comprises a light guide arranged parallel to the light output window and having an edge wall through which an (array) of light sources emit light into the light guide. The light is guided substantially parallel to the light output window and is distributed throughout the light guide. The light is emitted through the light output window by redirecting part of the guided light. A drawback of this edge-lit configuration, especially for relatively large display devices, is that the weight of the light guide is considerable and that it is relatively difficult to generate a good uniformity especially at an area of the large light output window where the light is coupled into the light guide. To improve this uniformity, wedge-shaped light guides as in US 2007/0086184 are used. However, these wedge-shaped light guides further increase the weight and are also relatively difficult to manufacture for large light output windows and thus expensive. Furthermore, the arrangement of the light sources at the edge wall of the light guide generally generates a relatively broad and thick rim around the display device which, next to the less aesthetic appearance of the display, also requires additional space when, for example, integrating the display device in a further application or housing.

So a drawback of this known illumination system is that the illumination system is relatively thick, especially at the edge region of the illumination system.

### OBJECT AND SUMMARY OF THE INVENTION

It is an object of the invention to provide a light guide for illuminating an output window of an illumination system in which the light guide enables a reduced thickness at the edge region of the illumination system.

According to a first aspect of the invention the object is achieved with a light guide for illuminating a light output window of an illumination system. The light guide comprises a first light guide part and a second light guide part, each having a front wall, a rear wall arranged opposite the front wall and edge walls between the front wall and the rear wall. The first light guide part and the second light guide part each are arranged for guiding light in a direction substantially parallel to the front wall and each further comprises light-extraction means for extracting at least part of the guided light via the front wall.

The first light guide part comprises a first light guide extension extending from a first edge wall of the first light guide part, and comprising a first light input window for transmitting light via the first light guide extension into the first light guide part. A width of the first light guide extension at the first edge wall is smaller than a width of the first edge wall.

The second light guide part comprises a second light guide extension extending from a second edge wall of the second light guide part and comprising a second light input window for transmitting light via the second light guide extension into the second light guide part. A width of the second light guide extension at the second edge wall is smaller than a width of the second edge wall.

The first light guide extension is configured for positioning the first light input window at a side of the second light guide part facing the rear wall of the second light guide part. The second light guide extension is configured for positioning the second light input window at a side of the first light guide part facing the rear wall of the first light guide part.

The width of the first light guide part and the second light guide part is a dimension parallel to the front wall of the first light guide part and the second light guide part and is defined substantially parallel to the first edge wall of the first light guide part and/or substantially parallel to the second edge wall of the second light guide part. The first light guide extension and the second light guide extension are connected to the first light guide and the second light guide, respectively. The first light guide extension and the second light guide extension may be an extrusion from the first edge wall of the first light guide and of the second edge wall of the second light guide, respectively. Alternatively, the first and second light guide extension may be, for example, a relatively narrow light conductor for conducting light from the light source into the first light guide part and the second light guide part, respectively.

The effect of the light guide according to the invention is that due to the configuration of the first light guide extension and the second light guide extension, the first light input window of the first light guide part is arranged behind the second light guide part, and the second light input window of the second light guide part is arranged behind the first light guide part. The word “behind” here indicates a location with respect to the light guide part which is located on a side of the light guide part opposite from the side from which light is emitted by the light guide part. The light emitting side of the light guide is denoted with the “front” of the light guide part. When using a light guide according to the invention in an illumination system, the light source may be hidden from view and may be placed away from the edge of the illumination system. Due to the use of the first and second light guide extensions, the light source emitting light into the first light guide part may be hidden from view behind the second light guide part, and the light source emitting light into the second light guide part may be hidden from view behind the first light guide part. All this may be accomplished while preventing any light source to be placed at an edge of the illumination system, and consequently the illumination system may be produced having reduced thickness at the edge region of the illumination system. In an embodiment in which the light guide comprises, for example, more that two light guide parts, such light guide may have a plurality of light guide parts in which the light input window is positioned behind a neighboring light input window. However, to ensure that no light source needs to be placed at the edge of the illumination system, and thus to ensure that the thickness of the edge region of the illumination system remains thin, at least two light guide parts are required which have a first light guide extension and a second light guide extension, respectively, according to the invention.

In an embodiment of the light guide, the first light input window is positioned on a normal axis of the front wall of the second light guide part, and the second light input window is positioned on a normal axis of the front wall of the first light guide part. A normal axis typically is an imaginary axis being arranged perpendicular to a surface, in this case, perpendicular to the front wall of the first light guide part or second light guide part. In such an arrangement, the first light input window actually is positioned behind the second light guide part and the second light input window actually is positioned behind the first light guide part. This light guide has the advantage that it enables a relatively compact illumination system. This compact illumination system is especially enabled due to the availability of relatively small high power light sources such as emitting diodes which may be located at the light input window of the light guide parts, behind the neighboring light guide parts.

In an embodiment of the light guide, the first light guide part is configured for reducing a distance between the first light guide part and the light output window towards a first edge of the light output window, and the second light guide part is configured for reducing a distance between the second light guide part and the light output window towards a second edge of the light output window different from the first edge. When using such a light guide in an illumination system, the thickness of this illumination system reduced towards the edge of the illumination system. The thickness of the illumination system is a dimension which is measured in a direction perpendicular to the light output window. In such an arrangement, the light guide may even contact the light output window at the edge of the illumination system, generating a substantially minimum thickness of the illumination system at the edge of the light output window. In the arrangement according to the invention the light input window is arranged at a maximum thickness of the illumination system being a maximum distance away from the light output window. This arrangement has the advantage that the additional distance between the first light guide part near the light source and the light output window allows light emitted from the first light guide part near the light source to be mixed before being emitted by the illumination system. Generally, a density of the light light-extraction means is relatively low near the light source and increases when the distance to the light source increases. The reason for this gradient in the light light-extraction means is that the overall intensity of the light which is emitted from the light guide preferably is substantially constant across the front wall. Because the intensity of the light near the light source is higher than further away from the light source, only a few light light-extraction means are required near the light input window of the light guide. However, to maintain a relatively high uniformity across the light output window of the illumination system, the areas of the light guide having relatively few light-extraction means preferably are located further away from the light output window as otherwise the few light-extraction means may be individually visible at the light output window even when a diffuser would be arranged at the light output window. This would generate a relatively poor uniformity. In the arrangement according to the invention, the light input window of the light guide is arranged away from the edge of the light output window of the illumination system. As such, the distance between the light input window and the light output window of the illumination system is relatively large, allowing the scattered light from the few light-extraction means to mix before impinging on the light output window. Near the edge of the light output window of the illumination system, the density of the light light-extraction means in the arrangement according to the invention has to be increased to obtain sufficient light out-coupling which causes the out-coupled light to be more uniform. Thus, reducing the distance between the light guide and the light output window near the edge of the light output window where the density of the light light-extraction means is relatively high would not reduce the uniformity. As such, the light guide according to the invention enables a relatively good uniformity across the light output window of the illumination system.

In an embodiment of the light guide, the first light guide part and the second light guide part each comprise a substantially constant thickness being a minimum dimension between the front wall and the rear wall. This embodiment has the advantage that the weight of the light guide according to the invention is relatively low and that the weight of the illumination system comprising the light guide is relatively low. The light guide may be relatively thin which limits the weight in comparison to, for example, a wedge shaped light guide in the known illumination systems. The space between the light guide and the light output window may be filled with a fluid, for example, air. Preferably the fluid between the light guide and the light output window allows the light guided in the light guide to propagate via total internal reflection through the light guide as this allows a substantially loss-less guiding of the light. Using air in between the light guide and the light output window further reduces the weight of the illumination system according to the invention.

In an embodiment of the light guide, the light guide is configured for guiding light entering the first light guide part via the first light input window in a substantially opposite direction compared to light entering the second light guide part via the second input window. Substantially opposite means that the component of the guidance of the light parallel to the light output window is in opposite directions for the first light guide part compared to the second light guide part, while another component of the guidance of the light in the first light guide part and the second light guide part may be in any other direction. The light source may, for example, be located substantially in the center of the light output window emitting light. The first light guide part and the second light guide part guide the light of the light source in a general direction parallel to the light output window from the center to the edge. As such, light traveling away from the light source through the first light guide part and the second light guide part travels substantially in opposite directions.

In an embodiment of the light guide, the first light guide part comprises one or more first light guide extensions extending from the first edge wall and forming a first pattern of first light guide extensions at the first edge wall, and the second light guide part comprises one or more second light guide extensions extending from the second edge wall and forming a second pattern of second light guide extensions at the second edge wall, the first pattern of first light guide extensions and second pattern of second light guide extensions being interrelated patterns. The first pattern may, for example, comprise a sequence of first light guide extensions which stretch out from the first light guide part as fingers from a hand. The second pattern may, for example, form a similar finger pattern which may be interwoven with the first pattern of the first light guide part. At the end of the extensions in the pattern of extensions—so to say at the fingertips of the fingers of the pattern—a light input window may be located. At each of these light input windows at the end of the light guide extensions one or a plurality of light sources may be arranged which emit light through the sequence of extensions into the connected light guide part. For example, the first pattern of first light guide extensions may comprise light sources which emit light via the first light input window at the first light guide extension, via the first light guide extension into the first light guide part.

In an embodiment of the light guide, the width of the first light guide extension increases away from the first edge wall, and/or the width of the second light guide extension increases away from the second edge wall. The light input window is arranged at a maximum width of the light guide extension. This embodiment has an advantage that the light progressing via the light guide extension to the light guide part is reflected multiple times between the walls of the light guide extensions which causes the light entering the light guide part from the light guide extension to spread out relatively widely. When using light guide extensions for guiding light into a light guide part a light intensity inside the light guide part at the area where the light guide extension is connected to the light guide part is relatively high. However, in the area between the locations where the light guide extensions connect to the light guide, the intensity is typically relatively low. This results in a non-uniform light distribution inside the light guide part. By using the first light guide extension and the second light guide extension as claimed in the current embodiment, the spreading of the light when it enters the light guide part is increased. In the first light guide part, the use of the first light guide extension of which the width increases from the first edge wall improves the uniformity of the light in the first light guide part near the first edge wall. In the second light guide part, the use of the second light guide extension of which the width increases from the second edge wall improves the uniformity of the light in the second light guide part near the second edge wall.

In an embodiment of the light guide, the first light guide extension and the second light guide extension are configured for positioning the first light input window and the second light input window to coincide with a same imaginary plane. To achieve such an arrangement, the first light guide extension may be curved, for example, away from the light output window, and the second light guide extension may also be curved, for example, away from the light output window. In such an arrangement, the imaginary plane may, for example, be parallel to the light output window. This embodiment has an advantage that a single light source may be used to illuminate the first light input window and the second light input window. Alternatively, when a plurality of light sources may be used to illuminate the first light input window and the second light input window, each of the plurality of light sources may be placed on a single printed circuit board (also further referred to as PCB). Using a single PCB reduces the cost of the illumination system comprising the light guide, as fewer components are required. Furthermore, the light sources typically have to be cooled and using a single PCB enables to also provide a single cooling arrangement for cooling the plurality of light sources, further reducing the cost of the illumination system.

In an embodiment of the light guide, a first opposite edge wall of the first light guide part arranged opposite the first edge wall comprises reflection means and/or diffusion means for redirecting light in the first light guide part towards the first edge wall at an area between the first light guide extensions, and a second opposite edge wall of the second light guide part arranged opposite the second edge wall comprises reflection means and/or diffusion means for redirecting light in the second light guide part towards the second edge wall at an area between the second light guide extensions. As indicated before, the area of the first edge wall between the first light guide extensions may comprise reduced light intensity. Also the area of the second edge wall between the second light guide extensions may comprise reduced light intensity. Using reflection and/or diffusion means may enhance the uniformity by deliberately reflecting light towards the area between the first light guide extensions at the first edge wall and between the second light guide extensions at the second edge wall.

In an embodiment of the light guide, the first light guide extension comprises light-extraction means at a first extraction-region near the first edge wall, and/or the second light guide extension comprises light-extraction means at a second extraction-region near the second edge wall. The first light guide part may be connected via the first edge well to the second edge wall of the second light guide part. Consequently, the light guide substantially emits light across the whole area of the light guide which faces the light output window of the illumination system. However, to ensure that the light emitted across the whole light guide comprising the first light guide part and the second light guide part is substantially homogeneous, the first light guide extension and the second light guide extension already comprise light-extraction means such as light light-extraction means. The light light-extraction means are typically arranged to generate a substantially uniform light distribution across the light output window. Generally the distribution of the light light-extraction means across the light guide is such that a relatively low density of the light-extraction means is arranged near the light source and that the density of the light-extraction means increases as the distance from the light source increases. The distribution of the light light-extraction means may change gradually or step-wise. Alternatively the distribution of the light light-extraction means may be such as to generate a predetermined light distribution which may, for example, not be uniform across the light output window. The light light-extraction means may, for example, be symmetrical grooves, asymmetrical grooves, pyramidal indentations, ridges, microdots, slanted slits, merlon structures, and conical indentations either arranged, for example, at the front wall or at the rear wall. Alternatively, the light light-extraction means may be scattering material distributed in the light guide. For example, when the light guide is constituted of polymethylmetaacrylate (further also indicated as PMMA), the scattering material may be mixed with the PMMA before the PMMA is solidified.

In an embodiment of the light guide, a dimension of the first extraction-region in a direction substantially perpendicular to the first edge wall is equal or larger than the width of the first light guide extension at the first edge wall, and/or a dimension of the second extraction-region in a direction substantially perpendicular to the second edge wall is equal or larger than the width of the second light guide extension at the second edge wall. Simulations have shown that this dimension of the first extraction-region and the second extraction-region is preferred to ensure a substantially homogeneous illumination of the light output window by the first light guide part and the second light guide part while having the first edge wall connecting the second edge wall.

The invention also relates to an illumination system comprising at least one light source, a light output window and the light guide according to the invention, the illumination system being configured for emitting light from the at least one light source via the light guide to the light output window of the illumination system.

In an embodiment of the illumination system, the illumination system further comprises a luminescent material or comprises a mixture of luminescent materials for converting at least part of the light emitted by the light source into light having a longer wavelength. The luminescent material may, for example, be arranged on the front wall and/or on the rear wall of the light guide or may be arranged on a separate substrate arranged between the light source and the light output window. Alternatively the luminescent material may be arranged on the light output window. Such an arrangement of the luminescent material is also known as a remote phosphor arrangement. The benefit when having the luminescent material remote from the light source is that the efficiency of the luminescent material is improved, the range of luminescent materials to choose from is improved due to the lower temperature requirements of the luminescent material in the remote phosphor arrangement, and the remote luminescent material also acts as a diffuser layer which diffuses the light emitted by the light source avoiding the use of a separate diffuser.

The invention also relates to a backlighting system comprising the light guide according to the invention, or comprising the illumination system according to the invention.

The invention also relates to a display device comprising the light guide according to the invention, or comprising the illumination system according to the invention, or comprising the backlighting system according to the invention.

### BRIEF DESCRIPTION OF THE DRAWINGS

These and other aspects of the invention are apparent from and will be elucidated with reference to the embodiments described hereinafter.

In the drawings:

FIG. 1A is a simplified cross-sectional view of a first embodiment of the illumination system comprising the light guide according to the invention, and FIG. 1B, is a simplified top-view of the first embodiment shown in FIG. 1A,

FIG. 2A is a simplified cross-sectional view of a second embodiment of the illumination system comprising the light guide according to the invention, and FIG. 2B, is a simplified top-view of the second embodiment shown in FIG. 2A,

FIGS. 3A to 3D are simplified cross-sectional views of a third to sixth embodiment of the illumination system comprising the light guide according to the invention,

FIGS. 4A and 4B are simplified top-views of a seventh and eighth embodiment of the illumination system comprising the light guide according to the invention, and

FIG. 5 is a simplified cross-sectional view of the display device according to the invention comprising the backlighting system according to the invention.

The figures are purely diagrammatic and not drawn to scale. Particularly for clarity, some dimensions are exaggerated strongly. Similar components in the figures are denoted by the same reference numerals as much as possible.

### DETAILED DESCRIPTION OF EMBODIMENTS

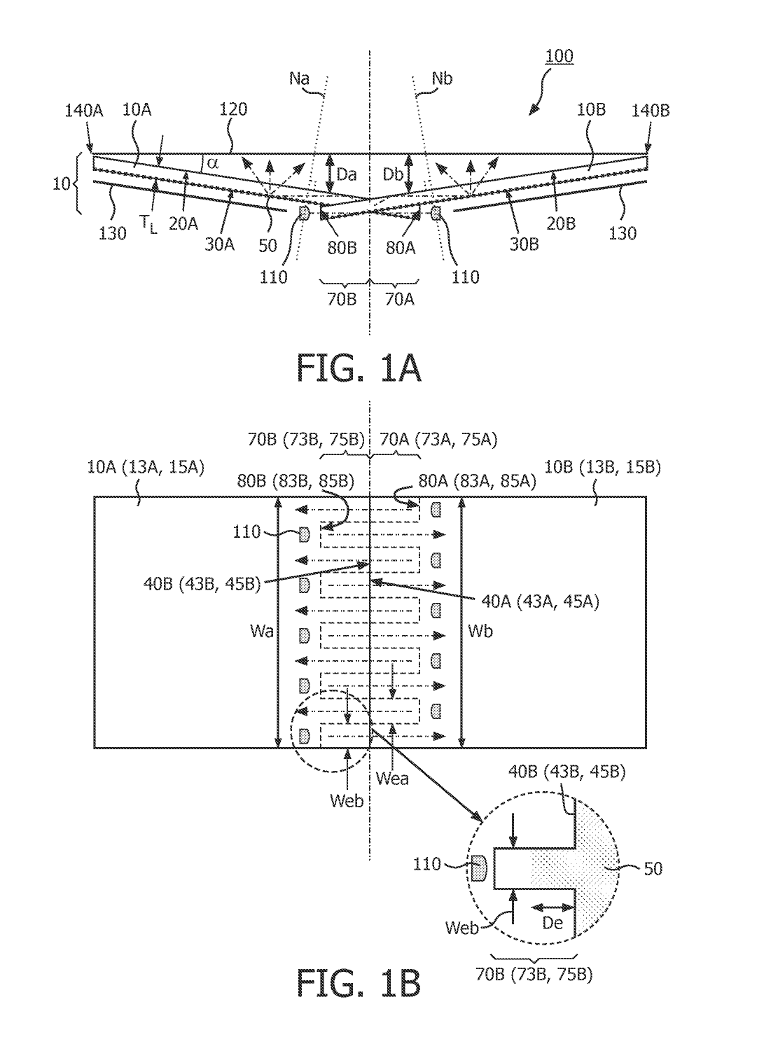

FIG. 1A is a simplified cross-sectional view of a first embodiment of the illumination system 100 comprising the light guide 10 according to the invention. The light guide 10 comprises a first light guide part 10A and a second light guide part 10B, each having a front wall 20A, 20B, a rear wall 30A, 30B arranged opposite the front wall 20A, 20B and edge walls 40A, 40B (see FIG. 1B) between the front wall 20A, 20B and the rear wall 30A, 30B. The first light guide part 10A and the second light guide part 10B each are arranged for guiding light in a direction substantially parallel to the front wall 20A, 20B (indicated in the figures with a dash-dot-dot-line or with a dash-dot-dot-arrow) and each further comprises light-extraction means 50 for extracting at least part of the guided light via the front wall 20A, 20B. The first light guide part 10A comprises a first light guide extension 70A which extends from a first edge wall 40A (see FIG. 1B) of the first light guide part 10A. The first light guide extension 70A comprises a first light input window 80A for transmitting light via the first light guide extension 70A into the first light guide part 10A after which the light is distributed inside the first light guide part 10A. A width Wea (see FIG. 1B) of the first light guide extension 70A at the first edge wall 40A is smaller than a width Wa (see FIG. 1B) of the first edge wall 40A. The second light guide part 10B comprises a second light guide extension 70B which extends from a second edge wall 40B (see FIG. 1B) of the second light guide part 10A. The second light guide extension 70B comprises a second light input window 80B for transmitting light via the second light guide extension 70B into the second light guide part 10B, after which the light is distributed inside the second light guide part 10B. A width Web (see FIG. 1B) of the second light guide extension 70B at the second edge wall 40B is smaller than a width Wb (see FIG. 1B) of the second edge wall 40B.

The first light guide extension 70A is configured for positioning the first light input window 80A at a side of the second light guide part 10B facing the rear wall 30B of the second light guide part 10B, and the second light guide extension 70B is configured for positioning the second light input window 80B at a side of the first light guide part 10A facing the rear wall 30A of the first light guide part 10A. Due to the configuration of the first light guide extension 70A and the second light guide extension 70B, the first light input window 80A of the first light guide part 10A is located behind the second light guide part 10B, and the second light input window 80B of the second light guide part 70B is located behind the first light guide part 10A. The word “behind” here indicates a location with respect to the light guide part 10A, 10B which is located on a side of the light guide part 10A, 10B opposite from the side from which light is emitted by the light guide part 10A, 10B. Consequently, the light source 110 may be hidden from view, fully behind the light guide 10, while still the light source 110 may be placed away from the edge 140A, 140B of light output window 120 of the illumination system 100. Consequently the illumination system 100 may be produced having reduced thickness at the edge region of the illumination system 100.

The light guide 10 is preferably arranged to guide the light using total internal reflection causing the guiding of the light through the light guide 10 to be substantially lossless. The light light-extraction means 50 of the light guide 10 may be distributed such that the density of light-extraction means 50 is relatively low near the light source 110 and increases when the distance to the light source 110 increases. The distribution of the light light-extraction means 50 may change gradually or step-wise. Alternatively the distribution of the light light-extraction means 50 may be such as to generate a predetermined light distribution across the light output window 120 which may, for example, not be uniform across the light output window 120. The light light-extraction means 50 may, for example, be symmetrical grooves, asymmetrical grooves, pyramidal indentations, ridges, microdots, slanted slits, merlon structures, and conical indentations either arranged, for example, at the front wall 20A, 20B or at the rear wall 30A, 30B. Alternatively, the light light-extraction means 50 may be scattering material (not shown) distributed in the light guide 10.

In the embodiment of the illumination system 100 and light guide 10 as shown in FIG. 1A, the first light guide part 10A and the second light guide part 10B are configured for reducing a distance Da, Db between the light guide part 10A, 10B and the light output window 120 towards a first edge 140A and the second edge 140B, respectively, of the light output window 120. When using such a light guide 10 in an illumination system 100, the thickness of this illumination system 100 reduces towards the edge 140A, 140B of the illumination system 100. In addition, the distance between the light guide part 10A, 10B and the light output window 120 in the center of the illumination system 100 ensures that light emitted by the light guide part 10A, 10B near the light source 110 is mixed before it reaches the light output window 120. In the embodiment shown in FIG. 1A, the first light guide part 10A and the second light guide part 10B both are inclined at an angle α with respect to the light output window 120.

The first light guide part 10A and the second light guide part 10B each comprise a substantially constant thickness T_{L} being a minimum dimension between the front wall 20A, 20B and the rear wall 20A, 20B. This embodiment has the advantage that the weight of the light guide 10 according to the invention is relatively low and thus that the weight of the illumination system 100 comprising the light guide 10 is relatively low. Using air in between the light guide 10 and the light output window 120 of the illumination system 100 further reduces the weight of the illumination system 100 according to the invention.

As shown in FIG. 1A, the light source 110 which emits light into the second light guide part 10B is positioned on a normal axis Na of the front wall 20A of the first light guide part 10A. The light source 110 which emits light into the first light guide part 10A is positioned on a normal axis Nb of the front wall 20B of the second light guide part 10B. As such, the light source 110 is hidden from view behind the light guide 10 while still the edges 140A, 140B of the illumination system 100 may be slim.

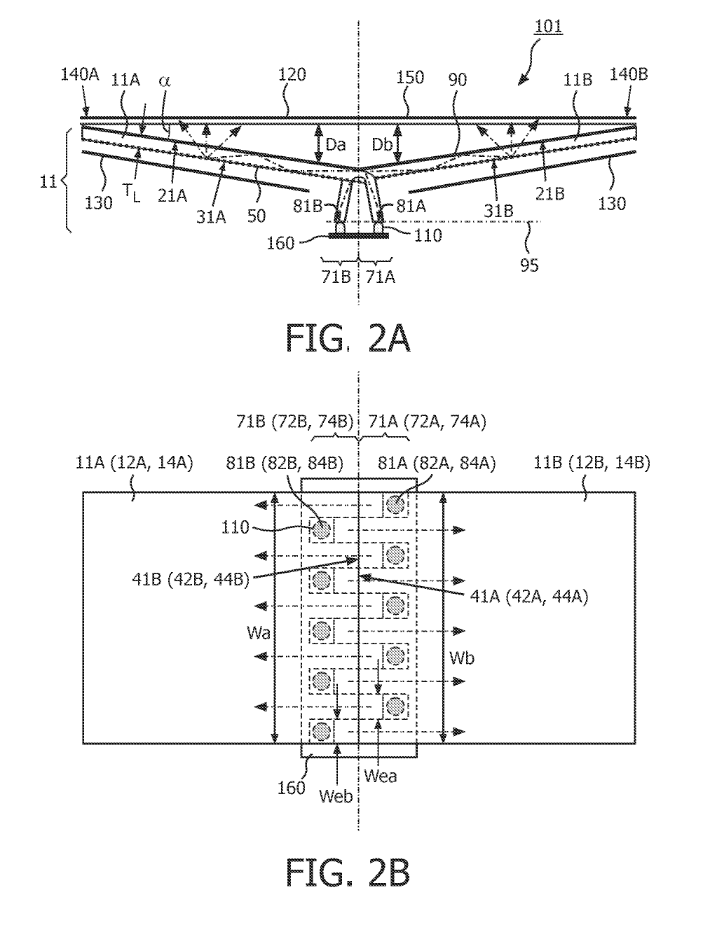

The light source 110 may be any light source emitting light via the light input window 80A, 80B. The light source 110 may, for example, be a light emitting diode 110, a laser diode 110, an organic light emitting diode 110 or any other light source 110, for example, a low-pressure gas discharge lamp (not shown) such as a cold cathode fluorescent light source (not shown). The light source 110 may, for example, emit substantially white light, and/or the light source may comprise a plurality of light-emitters (not shown) emitting light of a plurality of predefined colors which, when mixed, provide light of a predefined color. In this context, light of a predefined color typically comprises light having a predefined spectrum. The predefined spectrum may, for example, comprise a primary color having a specific bandwidth around a predefined wavelength, or may, for example, comprise a plurality of primary colors. The predefined wavelength is a mean wavelength of a radiant power spectral distribution. In this context, light of a predefined color also includes non-visible light, such as ultraviolet light. When ultraviolet light is emitted by the light source 110, typically a light conversion medium is used, such as a luminescent material 90 (see FIG. 2A). The luminescent material 90, for example, converts the ultraviolet light into visible light. The conversion medium may be directly applied on the light source 110 (not shown) or may be applied remote from the light source 110 (see FIG. 2A). The light of a primary color, for example, includes Red, Green, Blue, Yellow, Amber, and Magenta light. Light of the predefined color may also comprise mixtures of primary colors, such as Blue and Amber, or Blue, Yellow and Red. By choosing, for example, a specific combination of the Red, Green and Blue light substantially every color can be generated by the illumination system, including white. Also other combinations of primary colors may be used in the light projection system which enables the generation of substantially every color, for example, Red, Green, Blue, Cyan and Yellow. The number of primary colors used in the color-tunable illumination system may vary.

In the embodiment shown in FIG. 1A a reflective surface 130 is arranged parallel to and opposite from the rear wall 30A, 30B of the light guide part 10A, 10B. This reflective surface 130 redirects light progressing away from the light output window 120 back to the light output window 120 to increase the efficiency of the illumination system 10.

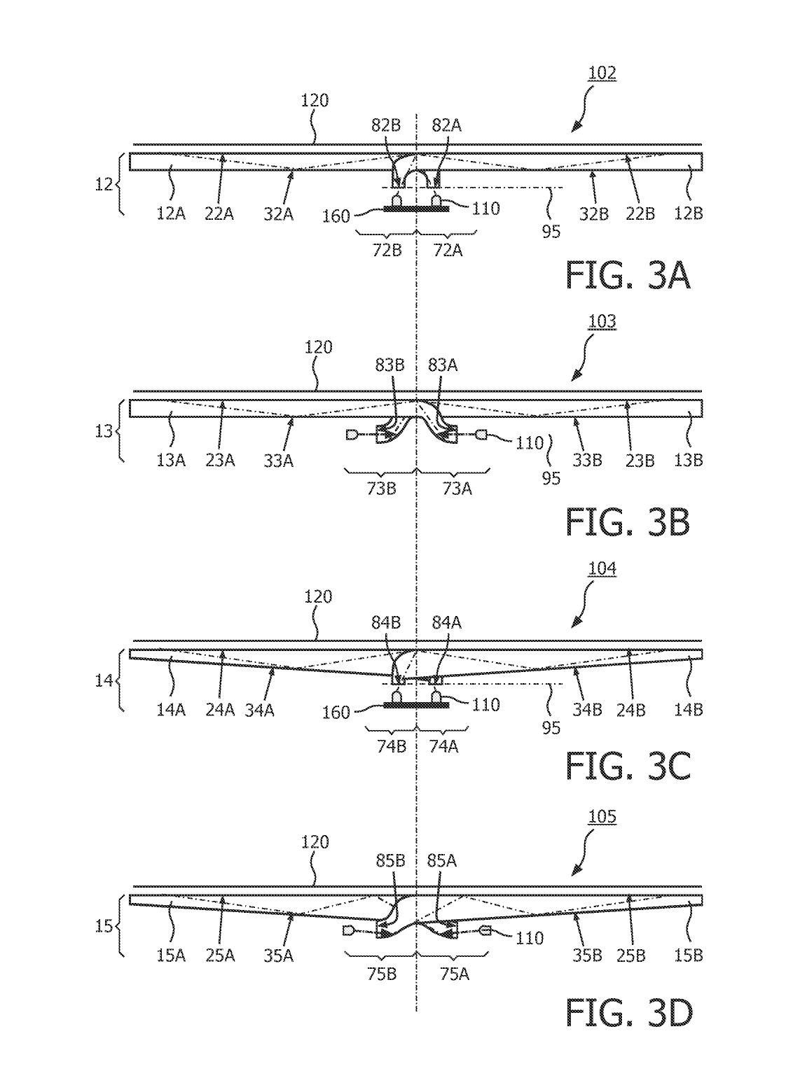

FIG. 1B is a simplified top-view of the first embodiment shown in FIG. 1A. The top-view of FIG. 1B also corresponds to the top-view of the embodiments shown in FIGS. 3B and 3D. The corresponding reference numbers belonging to the embodiments shown in FIGS. 3B and 3D have been added in brackets in FIG. 1B for completeness.

The first light guide part 10A comprises a plurality of first light guide extensions 70A forming a first pattern of first light guide extensions 70A. The second light guide part 10B comprises a plurality of second light guide extensions 70B forming a second pattern of second light guide extensions 70B. The first pattern of first light guide extensions 70A and second pattern of second light guide extensions 70B are interrelated patterns which means that the pattern may, for example, fit such that the first pattern of first light guide extensions 70A are interwoven with the second pattern of second light guide extensions 70B. As shown in FIG. 1B, the first pattern comprises a sequence of first light guide extensions 70A which stretch out from the first light guide part 10A as fingers from a hand. The second pattern forms a similar finger pattern which is configured to be interwoven with the first pattern of the first light guide part 10A. At the end of the light guide extensions 70A, 70B in the pattern of extensions—so to say at the fingertips of the fingers of the pattern—the light input window 80A, 80B is located. At each of these light input windows 80A, 80B one or a plurality of light sources 110 may be arranged which emit light through the sequence of light guide extensions 70A, 70B into the corresponding light guide part 10A, 10B.

In FIG. 1B a circular detail is enlarged showing the light source 110, the second light guide extension 70B connected to the second edge wall 40B of the second light guide part 10B. In this detail, the light extraction means 50 are indicated. As can be seen from this detailed part of FIG. 1B, the light extraction means 50 extend into the light guide extension 70B forming a light extraction region in the light guide extension 70B. This is required to ensure homogeneous illumination of the light output window 120 when the first light guide part 10A and the second light guide part 10B are connected as shown in FIG. 1B. The dimension De of the extraction region into the light guide extension 70B is preferably equal or larger than the width Web of the light guide extension 70B.

FIG. 2A is a simplified cross-sectional view of a second embodiment of the illumination system 101 comprising the light guide 11 according to the invention. In the embodiment shown in FIG. 2, the light guide extension 71A, 71B of the light guide 11 is curved away from the light output window 120. This curved part of the light guide extension 71A, 71B causes the light input window 81A, 81B of the first light guide part 11A and the second light guide part 11B to be arranged substantially parallel to the light output window 120. In the embodiment shown, a single light source 110 may be sufficient to provide the light into the first light guide part 11A, and the second light guide part 11B. In the schematic cross-sectional view shown in FIG. 2A, the curvature of the light guide extension 71A, 71B positions the first light input window 81A and the second light input window 81B to coincide with a same imaginary plane 95. In such an arrangement, the imaginary plane 95 may, for example, be parallel to the light output window 120. When a plurality of light sources 110 may be used to illuminate the first light input window 81A and the second light input window 81B (as indicated in FIG. 2A), each of the plurality of light sources 110 may be placed on a single printed circuit board 160 (also further referred to as PCB). Using a single PCB 160 reduces the cost of the illumination system 101 comprising the light guide 11, as fewer components are required. Furthermore, the light sources 110 typically have to be cooled and using a single PCB 160 enables to also provide a single cooling arrangement (not shown) for cooling the plurality of light sources 110, further reducing the cost of the illumination system 101.

Preferably the curvature of the light guide extension 71A, 71B is chosen such that still most of the light is guided by the first light guide part 11A and the second light guide part 11B via total internal reflection.

The illumination system 101 as shown in FIG. 2A further comprises an additional layer 150 on the light output window 120. This additional layer 150 may be a diffuser 150 and/or a brightness enhancement foil 150 and/or a redirection foil 150. The illumination system 101 may also comprise a luminescent material 90 or comprises a mixture of luminescent materials 90 for converting at least part of the light emitted by the light source 110 into light having a longer wavelength. In the embodiment shown in FIG. 2A the luminescent material 90 is arranged on the front wall 21A, 21B of the first light guide part 11A and the second light guide part 11B. Alternatively, the luminescent material 90 may be arranged on the rear wall 31A, 31B or may be mixed inside the light guide 11 or may be arranged on the light output window 120 of the illumination system 101.

FIG. 2B is a simplified top-view of the first embodiment shown in FIG. 2A. The top-view of FIG. 2B also corresponds to the top-view of the embodiments shown in FIGS. 3A and 3C. The corresponding reference numbers belonging to the embodiments shown in FIGS. 3A and 3C have been added in brackets in FIG. 2B for completeness.

The first light guide part 11A again comprises a plurality of first light guide extensions 71A forming a first pattern of first light guide extensions 71A. The second light guide part 11B comprises a plurality of second light guide extensions 71B forming a second pattern of second light guide extensions 71B. The first pattern of first light guide extensions 71A and second pattern of second light guide extensions 71B again are interrelated patterns which means that the pattern may, for example, fit such that the first pattern of first light guide extensions 71A are interwoven with the second pattern of second light guide extensions 71B as shown in FIG. 2B. Due to the curvature in the first light guide part 11A at the light guide extension 71A and due to the curvature in the second light guide part 11B at the light guide extension 71B, the first light input window 81A and the second light input window 81B are arranged substantially parallel to the light output window 120 enabling the plurality of light sources 110 to be arranged on a single PCB 160.

FIGS. 3A to 3D are simplified cross-sectional views of a third to sixth embodiment of the illumination system 102, 103, 104, 105 comprising the light guide 12, 13, 14, 15 according to the invention. Each light guide 12, 13, 14, 15, 16 is constituted by a first light guide part 12A, 13A, 14A, 15A which comprises a front wall 22A, 23A, 24A, 25A and a rear wall 32A, 33A, 34A, 35A, and by a second light guide part 12B, 13B, 14B, 15B which comprises a front wall 22B, 23B, 24B, 25B and a rear wall 32B, 33B, 34B, 35B. In the sequence of embodiments shown in FIGS. 3A to 3D, the front wall 22A, 23A, 24A, 25A, 22B, 23B, 24B, 25B of the light guide parts 12A, 13A, 14A, 15A, 12B, 13B, 14B, 15B all are substantially parallel to the light output window 120 of the illumination system 102, 103, 104, 105. This enables that the illumination system 102, 103, 104, 105 remains relatively thin at the edges of the light output window 120 and actually enables that the whole illumination system 102, 103, 104, 105 remains relatively thin.

FIGS. 3A and 3C both have a first light guide part 12A, 14A in which the first light guide extension 72A, 74A is curved away from the light output window 120 and a second light guide part 12B, 14B in which the second light guide extension 72B, 74B is curved away from the light output window 120. This curved part positions the first light input window 82A, 84A and the second light input window 82B, 84B to coincide with a same imaginary plane 95 which enables the light sources 110 to be positioned on a single PCT 160.

FIGS. 3B and 3D both have a first light guide part 13A, 15A in which the first light guide extension 73A, 75A is curved such that the first light input window 83A, 85A is arranged substantially perpendicular to the light output window 120, and in which the second light guide extension 73B, 75B is curved such that the second light input window 83B, 85B is arranged substantially perpendicular to the light output window 120. This shape of the light guide extensions 73A, 73B, 75A, 75B enables that the light source 110 is arranged directly behind the rear wall 33A, 33B, 35A, 35B of the light guide part 13A, 13B, 15A, 15B, which further reduces the overall height of the illumination system 103, 105.

The light guide parts 14A, 14B, 15A, 15B as shown in FIGS. 3C and 3D have a wedge-shape which may beneficially be used to ease the extraction of light from the light guide 14, 15. Extraction may be accomplished via the wedge shape of the light guide 14, 15, possibly in combination with additional extraction means and/or well known light redirection foils.

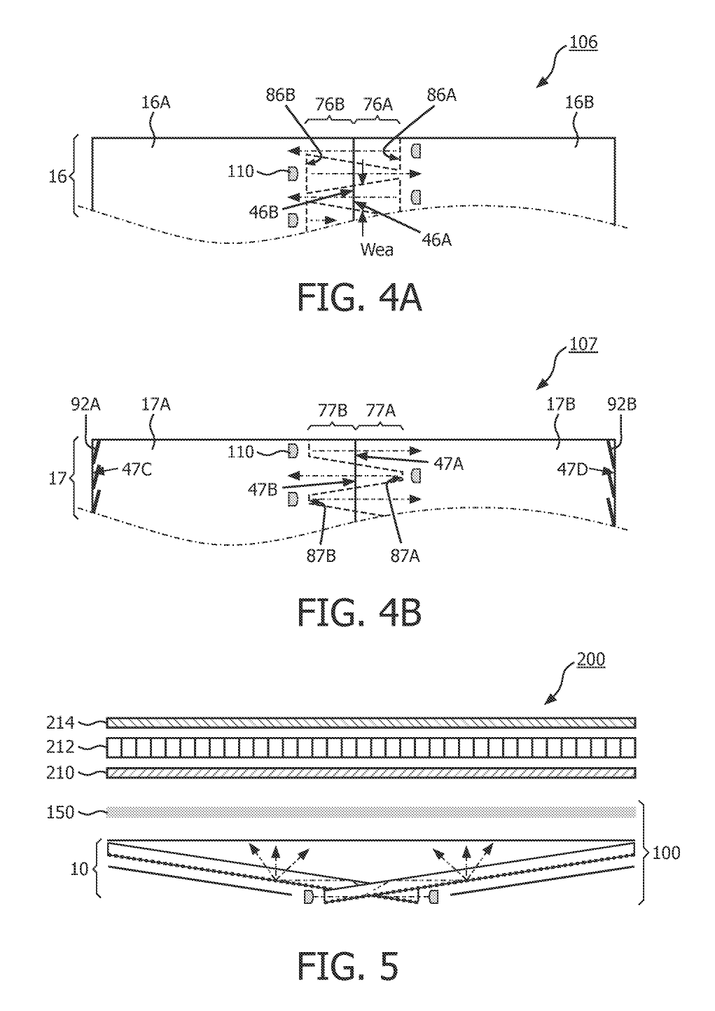

FIGS. 4A and 4B are simplified top-views of a seventh and eighth embodiment of the illumination system 106, 107 comprising the light guide 16, 17 according to the invention. The illumination systems 106, 107 shown in FIGS. 4A and 4B each comprise a first light guide part 16A, 17A and a second light guide part 16B, 17B, each having a front wall 26A, 26B, 27A, 27B (reference numbers not indicated in the figure), a rear wall 36A, 36B, 37A, 37B (reference numbers not indicated in the figure) and edge walls 46A, 46B, 47A, 47B. Each first light guide part 16A, 17A comprises first light guide extensions 76A, 77A having first light input window 86A, 87A. Each second light guide part 16B, 17B comprises second light guide extensions 76B, 77B having second light input window 86B, 87B.

In the embodiment of the light guide 16 as shown in FIG. 4A, the width Wea of the first light guide extension 76A increases away from the first edge wall 46A, and the width Web (not indicated in FIG. 4A) of the second light guide extension 76B increases away from the second edge wall 46B. The light input windows 86A, 86B are arranged at a maximum width of the light guide extensions 76A, 76B. This configuration ensures a relatively wide spreading of light when the light enters the light guide part 16A, 16B from the light guide extension 76A, 76B. This improves the uniformity of the light in the first light guide part 76A near the first edge wall 46A and improves the uniformity of the light in the second light guide part 76B near the second edge wall 46B.

In the embodiment of the light guide 17 as shown in FIG. 4B the first light guide part 17A and the second light guide part 17B each comprise reflection means 92A, 92B arranged at a first opposite edge wall 47C arranged opposite the first edge wall 47A, and arranged at a second opposite edge wall 47D arranged opposite the second edge wall 47B, respectively.

These reflection means 92A, 92B and/or diffusion means 92A, 92B may enhance the uniformity near the first edge wall 47A and the second edge well 47B by deliberately reflecting light towards the area between the first light guide extensions 77A at the first edge wall 47A and between the second light guide extensions 77B at the second edge wall 47B, thus improving the overall uniformity of the light spreading within the first light guide part 17A and the second light guide part 17B.

FIG. 5 is a simplified cross-sectional view of the display device 200 according to the invention comprising the backlighting system 100 according to the invention. The display device 200 may, for example, be a liquid crystal display device 200 which comprises a layer of electrically connected (not shown) liquid crystal cells 212, a polarizing layer 210, and an analyzing layer 214. Alternatively, the display device 200 may be any other non-emissive display device 200. The display device 200 comprises a backlighting system 100 comprising the illumination system 100 as shown in FIG. 1A. The backlighting system 100 further may comprise a diffuser layer 150. The diffuser layer 150 may constitute the light output window 120 (see FIG. 1) of the illumination system 100.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1. A light guide for illuminating a light output window of an illumination system,
the light guide comprising a first light guide part and a second light guide part, each having a front wall a rear wall, arranged opposite the front wall, and edge walls between the front wall and the rear wall, the first light guide part, and the second light guide part each being arranged for guiding light in a direction substantially parallel to the front wall and each further comprising light-extraction means for extracting at least part of the guided light via the front wall,
the first light guide part comprising a first light guide extension extending from a first edge wall of the first light guide part, and comprising a first light input window for transmitting light via the first light guide extension into the first light guide part, a width (Wea) of the first light guide extension at the first edge wall being smaller than a width (Wa) of the first edge wall,
the second light guide part comprising a second light guide extension extending from a second edge wall of the second light guide part and comprising a second light input window for transmitting light via the second light guide extension into the second light guide part, a width (Web) of the second light guide extension at the second edge wall being smaller than a width (Wb of the second edge wall,
the first light guide extension being configured for positioning the first light input window at a side of the second light guide part facing the rear wall of the second light guide part, the second light guide extension being configured for positioning the second light input window at a side of the first light guide part facing the rear wall of the first light guide part.

2. The light guide as claimed in claim 1, wherein the first light input window is positioned on a normal axis (Nb) of the front wall of the second light guide part, and wherein the second light input window is positioned on a normal axis (Na)of the front wall of the first light guide part.

3. The light guide as claimed in claim 1, wherein the first light guide part is configured for reducing a distance (Da) between the first light guide part and the light output window towards a first edge of the light output window, and wherein the second light guide part is configured for reducing a distance (Db) between the second light guide part and the light output window towards a second edge of the light output window different from the first edge.

4. The light guide as claimed in claim 1, wherein the first light guide part and the second light guide part each comprise a substantially constant thickness (T_{L}) being a minimum dimension between the front wall and the rear wall.

5. The light guide as claimed in claim 1, wherein the light guide is configured for guiding light entering the first light guide part via the first light input window in a substantially opposite direction compared to light entering the second light guide part via the second input window.

6. The light guide as claimed in claim 1, wherein the first light guide part comprises one or more first light guide extensions extending from the first edge wall and forming a first pattern of first light guide extensions at the first edge wall, and wherein the second light guide part comprises one or more second light guide extensions extending from the second edge wall and forming a second pattern of second light guide extensions at the second edge wall, the first pattern of first light guide extensions and second pattern of second light guide extensions being interrelated patterns.

7. The light guide as claimed in claim 1, wherein the width (Wea) of the first light guide extension increases away from the first edge wall and/or wherein the width (Web) of the second light guide extension increases away from the second edge wall.

8. The light guide as claimed in claim 1, wherein the first light guide extension and the second light guide extension are configured for positioning the first light input window and the second light input window to coincide with a same imaginary plane.

9. The light guide as claimed in claim 1, wherein a first opposite edge wall of the first light guide part arranged opposite the first edge wall comprises reflection means and/or diffusion means for redirecting light in the first light guide part, towards the first edge wall at an area between the first light guide extensions, and wherein a second opposite edge wall of the second light guide part arranged opposite the second edge wall comprises reflection means and/or diffusion means for redirecting light in the second light guide part towards the second edge wall at an area between the second light guide extension.

10. The light guide as claimed in claim 1, wherein the first light guide extension comprises light-extraction means at a first extraction-region near the first edge wall, and/or wherein the second light guide extension comprises light-extraction means at a second extraction-region near the second edge wall.

11. The light guide as claimed in claim 10, wherein a dimension (De) of the first extraction-region in a direction substantially perpendicular to the first edge wall is equal or larger than the width (Wea) of the first light guide extension at the first edge wall and/or wherein a dimension (De) of the second extraction-region in a direction substantially perpendicular to the second edge wall is equal or larger than the width (Web) of the second light guide extension at the second edge wall.

12. An illumination system comprising at least one light source, a light output window and the light guide as claimed in claim 1, the illumination system being configured for emitting light from the at least one light source via the light guide to the light output window of the illumination system.

13. The illumination system as claimed in claim 12, wherein the illumination system further comprises a luminescent material or comprises a mixture of luminescent materials for converting at least part of the light emitted by the light source into light having a longer wavelength.

14. Backlighting system comprising the light guide as claimed in claim 1.

15. Display device comprising the light guide as claimed in claim 1.
